(19) United States
(12) Patent Application Publication
(10) Pub. No.: US 2022/0315163 A1
(43) Pub. Date: Oct. 6, 2022

(54) HUMAN-POWERED VEHICLE CONTROL DEVICE

(71) Applicant: Shimano Inc., Osaka (JP)

(72) Inventors: Satoshi SHAHANA, Osaka (JP); Mitsuhiko KAWASAKI, Osaka (JP); Taketoshi SATO, Osaka (JP)

(21) Appl. No.: 17/700,935

(22) Filed: Mar. 22, 2022

(30) Foreign Application Priority Data
Mar. 31, 2021 (JP) 2021-061248
Oct. 28, 2021 (JP) 2021-176476

(51) Int. Cl. B62M 6/50; B62M 25/08

(52) U.S. Cl. CPC B62M 6/50; B62M 25/08

(57) ABSTRACT

A human-powered vehicle control device is provided for a human-powered vehicle having a transmission device and a motor, which is configured to apply a propulsion force to the human-powered vehicle. The human-powered vehicle control device includes an electronic controller configured to control a transmission device of a human-powered vehicle. The electronic controller is configured to restrict a shifting action of the transmission device until a predetermined condition is satisfied in a case where one of a control states of the motor is switched to a further one of the control states of the motor.

### CROSS-REFERENCE TO RELATED APPLICATIONS

This application claims priority to Japanese Patent Application No. 2021-061248, filed on Mar. 31, 2021, and Japanese Patent Application No. 2021-176476, filed on Oct. 28, 2021. The entire disclosures of Japanese Patent Application Nos. 2021-061248 and 2021-176476 are hereby incorporated herein by reference.

### BACKGROUND

### Technical Field

The present disclosure generally relates to a human-powered vehicle control device for a human-powered vehicle.

### Background Information

Japanese Laid-Open Patent Publication No. 2015-209159 (Patent Document 1) discloses an example of a human-powered vehicle control device that controls a transmission device in accordance with a control state of a motor configured to apply a propulsion force to a human-powered vehicle.

### SUMMARY

One objective of the present disclosure is to provide a human-powered vehicle control device for a human-powered vehicle configured to control a transmission device so that a rider is less likely to feel awkward when the rider is riding the human-powered vehicle.

A human-powered vehicle control device in accordance with a first aspect of the present disclosure is for a human-powered vehicle having a transmission device and a motor, which is configured to apply a propulsion force to the human-powered vehicle. The human-powered vehicle control device comprises an electronic controller configured to control a transmission device of the human-powered vehicle. The electronic controller is configured to restrict a shifting action of the transmission device until a predetermined condition is satisfied in a case where one of a control states of the motor is switched to a further one of the control states of the motor. With the human-powered vehicle control device according to the first aspect, the state of the transmission device is likely to be maintained until the predetermined condition is satisfied in a case where the control state of the motor is changed from one of the control states to a further one of the control states. This restricts shifting of the transmission device that is not intended by the rider in a case where the control state of the motor is changed. Thus, the rider is less likely to feel awkward in a case where the rider is riding the human-powered vehicle.

In accordance with a second aspect of the present disclosure, the human-powered vehicle control device according to the first aspect is configured so that the electronic controller is configured to change a transmission ratio with the transmission device in accordance with at least one of a traveling state of the human-powered vehicle and a traveling environment of the human-powered vehicle. With the human-powered vehicle control device according to the second aspect, the electronic controller automatically changes the transmission ratio of the transmission device in accordance with at least one of the traveling state of the human-powered vehicle and the traveling environment of the human-powered vehicle.

In accordance with a third aspect of the present disclosure, in the human-powered vehicle control device according to the second aspect, the electronic controller is configured to control the transmission device in accordance with a first parameter, related to the traveling state of the human-powered vehicle, and a predetermined first threshold value. The electronic controller is configured to change the predetermined first threshold value to restrict the shifting action of the transmission device. With the human-powered vehicle control device according to the third aspect, the electronic controller restricts the shifting action of the transmission device through a simple process. Thus, the processing load on the electronic controller is reduced.

In accordance with a fourth aspect of the present disclosure, in the human-powered vehicle control device according to the second or third aspect, the electronic controller is configured to control the transmission device in accordance with a second parameter, related to the traveling environment of the human-powered vehicle, and a predetermined second threshold value. The electronic controller is configured to change the predetermined second threshold value to restrict the shifting action of the transmission device. With the human-powered vehicle control device according to the fourth aspect, the electronic controller restricts the shifting action of the transmission device through the simple process.

In accordance with a fifth aspect of the present disclosure, the human-powered vehicle control device according to any one of the first to fourth aspects is configured so that the predetermined condition is satisfied in a case where a predetermined first period elapses from when switching from the one of the control states to the further one of the control states. With the human-powered vehicle control device according to the fifth aspect, the electronic controller hinders the transmission device from changing the transmission ratio immediately after one of the control states is changed to a further one of the control states.

In accordance with a sixth aspect of the present disclosure, the human-powered vehicle control device according to the fifth aspect is configured so that the predetermined first period includes a predetermined first time. The human-powered vehicle control device according to the sixth aspect uses the predetermined first time as the predetermined first period. Thus, the amount of time for which shifting is restricted is fixed regardless of the travel speed of the human-powered vehicle.

In accordance with a seventh aspect of the present disclosure, the human-powered vehicle control device according to the sixth aspect is configured so that the predetermined first time is greater than or equal to one second and less than or equal to five seconds. The human-powered vehicle control device according to the seventh aspect hinders the transmission device from changing the transmission ratio only when necessary.

In accordance with an eighth aspect of the present disclosure, the human-powered vehicle control device according to any one of the fifth to seventh aspects is configured so that the predetermined first period includes a period during which a rotation amount of a wheel of the human-powered vehicle becomes a predetermined rotation amount. The human-powered vehicle control device according to the eighth aspect uses the period during which the rotation amount of the wheel of the human-powered vehicle becomes the predetermined rotation amount as the predetermined first period. Thus, the amount of time for which shifting is restricted is changed in accordance with the travel speed of the human-powered vehicle.

In accordance with a ninth aspect of the present disclosure, the human-powered vehicle control device according to the eighth aspect is configured so that the predetermined rotation amount is greater than or equal to 360 degrees and less than or equal to 3600 degrees. The human-powered vehicle control device according to the ninth aspect hinders the transmission device from changing the transmission ratio while the wheel is rotating in a range from one rotation to ten rotations.

In accordance with a tenth aspect of the present disclosure, the human-powered vehicle control device according to any one of the first to ninth aspects is configured so that the case where the one of the control states is switched to the further one of the control states includes a case where the one of the control states is switched to the further one of the control states in a state in which acceleration of the human-powered vehicle in a traveling direction of the human-powered vehicle is greater than or equal to a predetermined first acceleration. The predetermined condition is satisfied in a case where the acceleration of the human-powered vehicle becomes less than a predetermined second acceleration that is less than or equal to the predetermined first acceleration. The human-powered vehicle control device according to the tenth aspect hinders the transmission device from changing the transmission ratio while the human-powered vehicle is accelerating at acceleration that is greater than or equal to the predetermined first acceleration in the traveling direction of the human-powered vehicle even if the control state of the motor is changed. Thus, the rider is less likely to feel awkward.

In accordance with an eleventh aspect of the present disclosure, the human-powered vehicle control device according to any one of the first to tenth aspects is configured so that the case where the one of the control states is switched to the further one of the control states includes a case where the one of the control states is switched to the further one of the control states in a state in which load on a rider of the human-powered vehicle is greater than or equal to a predetermined first load. The predetermined condition is satisfied in a case where the load on the rider is less than a predetermined second load that is less than or equal to the predetermined first load. The human-powered vehicle control device according to the eleventh aspect hinders the transmission device from changing the transmission ratio while the load on the rider of the human-powered vehicle is greater than or equal to the predetermined first load even if the control state of the motor is changed from one of the control states to a further one of the control states. Thus, the rider is less likely to feel awkward.

In accordance with a twelfth aspect of the present disclosure, the human-powered vehicle control device according to any one of the first to tenth aspects is configured so that the case where the one of the control states is switched to the further one of the control states includes a case where the one of the control states is switched to the further one of the control states and a crank of the human-powered vehicle is rotating in a state in which load on a rider of the human-powered vehicle is greater than or equal to a predetermined first load. The predetermined condition is satisfied in a case where the load on the rider is less than a predetermined second load that is less than or equal to the predetermined first load. The human-powered vehicle control device according to the twelfth aspect hinders the transmission device from changing the transmission ratio while the load on the rider of the human-powered vehicle is greater than or equal to the predetermined first load even if the control state of the motor is changed from one of the control states to a further one of the control states while the crank is rotating. Thus, the rider is less likely to feel awkward.

In accordance with a thirteenth aspect of the present disclosure, the human-powered vehicle control device according to any one of the first to twelfth aspects is configured so that the case where the one of the control states is switched to the further one of the control states includes a case where the one of the control states is switched to the further one of the control states in a state in which gradient of a road on which the human-powered vehicle is traveling is greater than or equal to a predetermined first gradient. The predetermined condition is satisfied in a case where the gradient of the road on which the human-powered vehicle is traveling becomes less than a predetermined second gradient that is less than or equal to the predetermined first gradient. The human-powered vehicle control device according to the thirteenth aspect hinders the transmission device from changing the transmission ratio while the gradient of the road on which the human-powered vehicle is traveling is greater than or equal to the predetermined first gradient even if the control state of the motor is changed from one of the control states to a further one of the control states. Thus, the rider is less likely to feel awkward.

In accordance with a fourteenth aspect of the present disclosure, the human-powered vehicle control device according to any one of the first to thirteenth aspects is configured so that the case where the one of the control states is switched to the further one of the control states includes a case where the one of the control states is switched to the further one of the control states in a state in which a pitch angle of the human-powered vehicle is greater than or equal to a predetermined first pitch angle. The predetermined condition is satisfied in a case where the pitch angle of the human-powered vehicle becomes less than a predetermined second pitch angle that is less than or equal to the predetermined first pitch angle. The human-powered vehicle control device according to the fourteenth aspect hinders the transmission device from changing the transmission ratio while the pitch angle of the human-powered vehicle is greater than or equal to the predetermined first pitch angle even if the control state of the motor is changed from one of the control states to a further one of the control states. Thus, the rider is less likely to feel awkward.

In accordance with a fifteenth aspect of the present disclosure, the human-powered vehicle control device according to any one of the first to fourteenth aspects is configured so that the control states differ from each other in an assist level of the motor. The case where the one of the control states is switched to the further one of the control states includes a case where the assist level of the motor is increased. The human-powered vehicle control device according to the fifteenth aspect hinders the transmission device from changing the transmission ratio in a case where the assist level of the motor increases.

In accordance with a sixteenth aspect of the present disclosure, the human-powered vehicle control device according to any one of the first to fifteenth aspects is configured so that the shifting action of the transmission device includes a shifting action that increases the transmission ratio with the transmission device. The human-powered vehicle control device according to the sixteenth aspect restricts an increase in the transmission ratio until the predetermined condition is satisfied in a case where one of the control states is switched to a further one of the control states. This avoids an increase in the load on the rider caused by the transmission device, so that the rider is less likely to feel awkward.

In accordance with a seventeenth aspect of the present disclosure, the human-powered vehicle control device according to any one of the first to sixteenth aspects is configured so that the shifting action of the transmission device includes a shifting action that decreases the transmission ratio with the transmission device. The human-powered vehicle control device according to the seventeenth aspect restricts a decrease in the transmission ratio until the predetermined condition is satisfied in a case where one of the control states is switched to a further one of the control states. This avoids a decrease in the load on the rider caused by the transmission device, so that the rider is less likely to feel awkward.

In accordance with an eighteenth aspect of the present disclosure, the human-powered vehicle control device according to any one of the first to fifteenth aspects is configured so that among a first shifting action that increases the transmission ratio with the transmission device and a second shifting action that decreases the transmission ratio with the transmission device, the shirting action of the transmission device includes only the first shifting action. The human-powered vehicle control device according to the eighteenth aspect restricts an increase in the transmission ratio until the predetermined condition is satisfied in a case where one of the control states is switched to a further one of the control states. This avoids an increase in the load on the rider caused by the transmission device, so that the rider is less likely to feel awkward. The human-powered vehicle control device according to the eighteenth aspect does not restrict a decrease in the transmission ratio until the predetermined condition is satisfied in a case where one of the control states is switched to a further one of the control states. This facilitates a decrease in the load on the rider caused by the transmission device.

In accordance with a nineteenth aspect of the present disclosure, in the human-powered vehicle control device according to any one of the first to eighteenth aspects, the electronic controller is configured to control the motor. With the human-powered vehicle control device according to the nineteenth aspect, the electronic controller that is further configured to control the transmission device and control the motor that is configured to apply a propulsion force to the human-powered vehicle.

In accordance with a twentieth aspect of the present disclosure, the human-powered vehicle control device according to any one of the first to nineteenth aspects further comprises an input unit configured to receive information related to the control states. The electronic controller is further configured to obtain the information related to the control states via the input unit. The human-powered vehicle control device according to the twentieth aspect obtains information related to the control states via the input unit.

The human-powered vehicle control device for a human-powered vehicle according to the present disclosure controls the transmission device so that a rider is less likely to feel awkward when the rider is riding the human-powered vehicle.

### BRIEF DESCRIPTION OF DRAWINGS

Referring now to the attached drawings which form a part of this original disclosure.

FIG. 1 is a side elevational view of a human-powered vehicle (e.g., a bicycle) including a human-powered vehicle control device in accordance with a first embodiment of.

FIG. 2 is a block diagram showing the electrical configuration of the human-powered vehicle including the human-powered vehicle control device of the first embodiment.

FIG. 3 is a flowchart of a process executed by an electronic controller shown in FIG. 2 for controlling a transmission device.

FIG. 4 is a flowchart of a process executed by the electronic controller shown in FIG. 2 for restricting a shifting action of the transmission device.

FIG. 5 is a flowchart of a process executed by a first modification of an electronic controller for restricting the shifting action of the transmission device.

FIG. 6 is a flowchart of a process executed by a second modification of an electronic controller for restricting the shifting action of the transmission device.

FIG. 7 is a flowchart of a process executed by a third modification of an electronic controller for restricting the shifting action of the transmission device.

FIG. 8 is a flowchart of a process executed by a fourth modification of an electronic controller for restricting the shifting action of the transmission device.

FIG. 9 is a flowchart of a process executed by a fifth modification of an electronic controller for restricting the shifting action of the transmission device.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

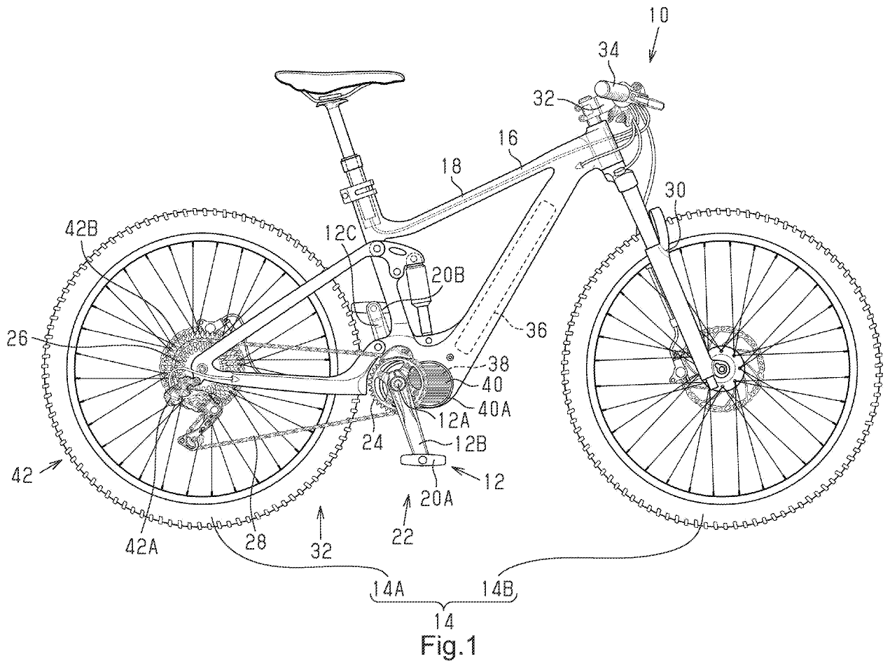

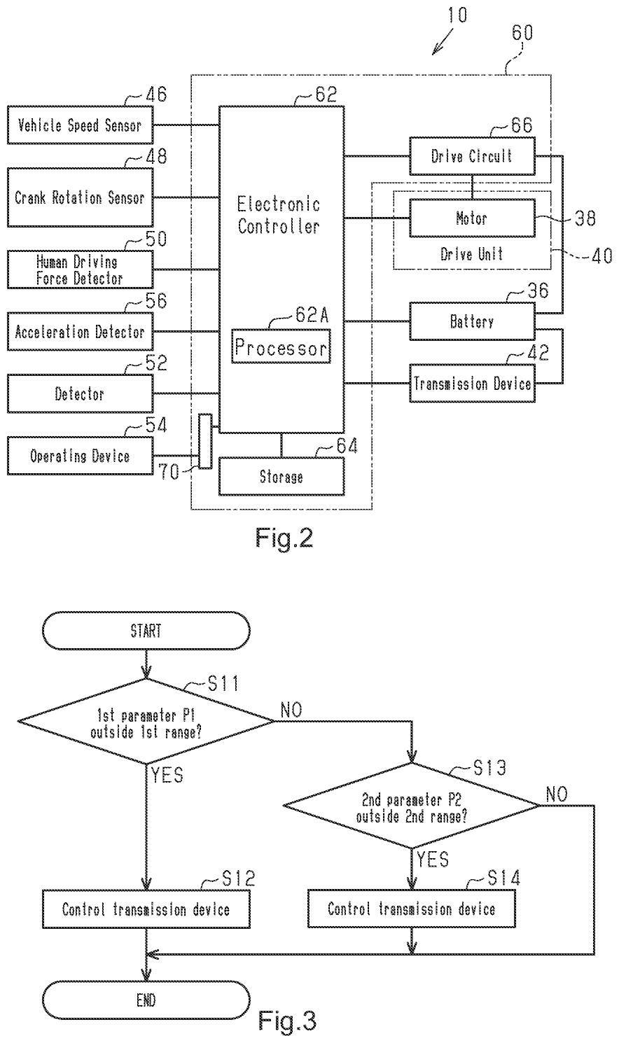

A first embodiment of a human-powered vehicle control device 60 for a human-powered vehicle will now be described with reference to FIGS. 1 to 4. A human-powered vehicle 10 is a vehicle including at least one wheel, and driven by at least a human driving force. The human-powered vehicle 10 includes, for example, various types of bicycles such as a mountain bike, a road bike, a city bike, a cargo bike, a hand bike, and a recumbent bike. The number of wheels on the human-powered vehicle 10 is not limited. The human-powered vehicle 10 includes, for example, a monocycle and a vehicle including three or more wheels. The human-powered vehicle 10 is not limited to a vehicle configured to be driven only by a human driving force. The human-powered vehicle 10 includes an E-bike that uses a driving force of an electric motor in addition to the human driving force for propulsion. The E-bike includes an electric assist bicycle that assists in propulsion using an electric motor. In the embodiment described below, the human-powered vehicle 10 refers to an electric assist bicycle. An example of the electric assist bicycle is a mountain bike.

The human-powered vehicle 10 includes at least one wheel 14 and a vehicle body 16. The at least one wheel 14 includes a rear wheel 14A and a front wheel 14B. The vehicle body 16 includes a frame 18. An input rotational axle 12A is provided on the vehicle body 16, and is rotatable relative to the frame 18. In the present embodiment, the input rotational axle 12A is a crank axle of a crank 12. The crank 12 includes the input rotational shaft 12A, a first crank arm 12B provided on one axial end of the input rotational shaft 12A, and a second crank arm 12C provided on the other axial end of the input rotational shaft 12A. A first pedal 20A is coupled to the first crank arm 12B. A second pedal 20B is coupled to the second crank arm 12C. The rear wheel 14A is driven in accordance with rotation of the crank 12. The rear wheel 14A is supported by the frame 18. The crank 12 and the rear wheel 14A are coupled by a drive mechanism 22.

The drive mechanism 22 includes a first rotary body 24 coupled to the input rotational shaft 12A. The input rotational shaft 12A and the first rotary body 24 can be coupled so as to rotate integrally with each other or can be coupled by a first one-way clutch. The first one-way clutch is configured to rotate the first rotary body 24 forward in a case where the crank 12 rotates forward and allow the first rotary body 24 to rotate relative to the crank 12 in a case where the crank 12 rotates rearward. The first rotary body 24 includes a front sprocket. The first rotary body 24 can include a pulley or a bevel gear. The drive mechanism 22 further includes a second rotary body 26 and a linking member 28. The linking member 28 transmits a rotational force of the first rotary body 24 to the second rotary body 26. The linking member 28 includes, for example, a chain, a belt, or a shaft.

The second rotary body 26 is coupled to the rear wheel 14A. The second rotary body 26 includes a rear sprocket. The second rotary body 26 can include a pulley or a bevel gear. Preferably, a second one-way clutch is provided between the second rotary body 26 and the rear wheel 14A. The second one-way clutch is configured to rotate the rear wheel 14A forward in a case where the second rotary body 26 rotates forward and allow the rear wheel 14A to rotate relative to the second rotary body 26 in a case where the second rotary body 26 rotates rearward.

The front wheel 14B is attached to the frame 18 by a front fork 30. A handlebar 34 is coupled to the front fork 30 by a stem 32. In the present embodiment, the rear wheel 14A is coupled to the crank 12 by the drive mechanism 22. However, any one of the rear wheel 14A and the front wheel 14B can be coupled to the crank 12 by the drive mechanism 22.

The human-powered vehicle 10 further includes a battery 36. The battery 36 includes one or more battery elements. The battery elements include a rechargeable battery. The battery 36 is configured to supply electric power to the human-powered vehicle control device 60. Preferably, the battery 36 is connected to an electronic controller 62 of the human-powered vehicle control device 60 by an electric cable or a wireless communication device to communicate with the electronic controller 62. The terms “controller” and “electronic controller” as used herein refers to hardware that executes a software program, and does not include a human being. The battery 36 is configured to communicate with the electronic controller 62 through, for example, power line communication (PLC), controller area network (CAN), or universal asynchronous receiver/transmitter (UART).

The human-powered vehicle 10 includes a motor 38, which is configured to apply a propulsion force to the human-powered vehicle 10, and a transmission device 42. The transmission device 42 is provided on a human driving force transmission path and has a transmission ratio R. The transmission ratio R is expressed by a ratio of rotational speed Vout of an output portion of the transmission device 42 to a rotational speed Vin of an input portion of the transmission device 42. The transmission ratio R is expressed by equation “R=Vout/Vin”. As the transmission ratio R is increased, a rotational speed C of the crank 12 is increased and transmitted to the wheel 14.

In the present embodiment, the transmission device 42 includes a derailleur 42A and a plurality of sprockets 42B having a rotational axis and aligned along the rotational axis. In a case where the derailleur 42A includes a rear derailleur, the sprockets 42B include the second rotary body 26. In a case where the derailleur 42A includes a front derailleur, the sprockets 42B include the first rotary body 24. In a case where the transmission device 42 is the derailleur 42A, the rotational speed of the output portion of the transmission device 42 corresponds to the rotational speed of the second rotary body 26. In a case where the transmission device 42 is the derailleur 42A, the rotational speed of the input portion of the transmission device 42 corresponds to the rotational speed of the first rotary body 24. The transmission device 42 can include an internal shifting device.

Preferably, the transmission device 42 includes an electric actuator. In a case where the transmission device 42 includes the derailleur 42A, the electric actuator is provided on the derailleur 42A and actuates the derailleur 42A. The electric actuator can be separated from the derailleur 42A and the internal shifting device and can be provided on, for example, the frame 18. The electric actuator includes an electric motor and a speed reducer. In a case where the electric actuator is provided on the frame 18, the electric actuator is connected to the derailleur 42A or the internal shifting device by, for example, a Bowden cable.

The motor 38 is configured to apply a propulsion force to the human-powered vehicle 10. The motor 38 includes one or more electric motors. The electric motor is, for example, a brushless motor. The motor 38 is configured to transmit a rotational force to at least one of the front wheel 14B and a power transmission path of the human driving force extending from the pedals 20A and 20B to the rear wheel 14A. The power transmission path of the human driving force extending from the pedals 20A and 20B to the rear wheel 14A includes the rear wheel 14A. In the present embodiment, the motor 38 is provided on the frame 18 of the human-powered vehicle 10 and is configured to transmit the rotational force to the first rotary body 24.

The motor 38 is provided on a housing 40A. The housing 40A is provided on the frame 18. The housing 40A is, for example, detachably attached to the frame 18. A drive unit 40 includes the motor 38 and the housing 40A on which the motor 38 is provided. In the present embodiment, preferably, a third one-way clutch is provided on the power transmission path between the motor 38 and the input rotational shaft 12A so that in a case where the input rotational shaft 12A is rotated in a direction in which the human-powered vehicle 10 travels forward, the rotational force of the crank 12 will not be transmitted to the motor 38. In a case where the motor 38 is provided on at least one of the rear wheel 14A and the front wheel 14B, the motor 38 can be provided on a hub and form a hub motor together with the hub.

The human-powered vehicle control device 60 includes the electronic controller 62. The electronic controller 62 includes a processor 62A that executes a predetermined control program. The processor of the electronic controller 62 includes, for example, a central processing unit (CPU) or a micro processing unit (MPU). The electronic controller 62 can include processors provided at positions separate from each other. The electronic controller 62 can include one or more microcomputers. Preferably, the human-powered vehicle control device 60 further includes storage 64. The storage 64 stores the predetermined control program and information used for control processes. The storage 64 includes any computer storage device or any non-transitory computer-readable medium with the sole exception of a transitory, propagating signal. For example, the storage 64 includes a nonvolatile memory and a volatile memory. The nonvolatile memory includes, for example, at least one of a read-only memory (ROM), an erasable programmable read only memory (EPROM), an electrically erasable programmable read-only memory (EEPROM), and a flash memory. The volatile memory includes, for example, a random access memory (RAM).

Preferably, the human-powered vehicle control device 60 further includes a drive circuit 66 of the motor 38. The drive circuit 66 and the electronic controller 62 are provided on, for example, the housing 40A of the drive unit 40. The drive circuit 66 and the electronic controller 62 can be provided, for example, on the same circuit substrate. The drive circuit 66 includes an inverter circuit. The drive circuit 66 controls electric power supplied from the battery 36 to the motor 38. The drive circuit 66 is connected to the electronic controller 62 by a conductive wire, an electric cable, or a wireless communication device. The drive circuit 66 drives the motor 38 in accordance with a control signal from the electronic controller 62.

The motor 38 is configured to be controlled by switching control states. Preferably, the electronic controller 62 is configured to control the motor 38. The human-powered vehicle control device 60 further includes an input unit 70 configured to receive information related to the control states. The electronic controller 62 is configured to obtain the information related to the control states via the input unit 70. The input unit 70 is electrically connected to the electronic controller 62. The input unit 70 includes at least one of a wireless communication device and a port to which an electric cable is detachably connected. An electric cable can be connected to the input unit 70 in an undetachable manner.

An operating device 54 is provided on the handlebar 34 of the human-powered vehicle 10. The operating device 54 includes, for example, an electrical switch that can be manually operated with a finger of the rider. The operating device 54 can include, for example, a smartphone. The operating device 54 can be electrically connected to the input unit 70 by an electric cable or can be connected to the input unit 70 through wireless communication. The operating device 54 transmits information related to control states to the input unit 70. The information related to the control states includes, for example, information for switching the control states. In a case where the operating device 54 is operated, the information related to the control states is input to the electronic controller 62 via the input unit 70.

Preferably, the electronic controller 62 controls the motor 38 in accordance with, for example, at least one of a vehicle speed V, a rotational speed C of the input rotational shaft 12A, and the human driving force. The human-powered vehicle 10 further includes at least one of a vehicle speed sensor 46, a crank rotation sensor 48, and a human driving force detector 50. The vehicle speed sensor 46 is configured to detect information related to a vehicle speed V of the human-powered vehicle 10. In the present embodiment, the vehicle speed sensor 46 is configured to detect information related to a rotational speed W of at least one wheel 14 of the human-powered vehicle 10. The vehicle speed sensor 46 is configured to detect, for example, a magnet provided on at least one wheel 14 of the human-powered vehicle 10. The terms “sensor” and as “detector” used herein refers to a hardware device or instrument designed to detect the presence or absence of a particular event, object, substance, or a change in its environment, and to emit a signal in response. The terms “sensor” and as “detector” as used herein does not include a human being.

The vehicle speed sensor 46 is configured to, for example, output a detection signal a predetermined number of times while at least one wheel 14 performs one rotation. The predetermined number of times is, for example, one. The vehicle speed sensor 46 outputs a signal corresponding to the rotational speed W of the wheel 14. The electronic controller 62 calculates the vehicle speed V of the human-powered vehicle 10 based on a signal corresponding to the rotational speed W of the wheel 14 and information related to the perimeter of the wheel 14. The information related to the perimeter of the wheel 14 is stored in the storage 64.

The vehicle speed sensor 46 includes, for example, a magnetic reed forming a reed switch or a magnetic sensor such as a Hall element. The vehicle speed sensor 46 can be attached to a chainstay of the frame 18 of the human-powered vehicle 10 and configured to detect a magnet attached to the rear wheel 14A or can be provided on the front fork 30 and configured to detect a magnet attached to the front wheel 14B. In the present embodiment, the vehicle speed sensor 46 is configured so that the reed switch detects the magnet once during one rotation of the wheel 14.

The vehicle speed sensor 46 can have any configuration that obtains information related to the vehicle speed V of the human-powered vehicle 10. The vehicle speed sensor 46 is not limited to a configuration that detects a magnet provided on the wheel 14 and can, for example, be configured to detect a slit provided on a disc brake, include an optical sensor, or include a global positioning system (GPS) receiver. In a case where the vehicle speed sensor 46 includes a GPS receiver, the electronic controller 62 can calculate the vehicle speed V based on time and a travelled distance. The vehicle speed sensor 46 is connected to the electronic controller 62 by a wireless communication device or an electric cable.

The crank rotation sensor 48 is configured to detect information related to rotational speed C of the input rotational shaft 12A. The crank rotation sensor 48 is provided, for example, on the frame 18 of the human-powered vehicle 10 or the drive unit 40. The crank rotation sensor 48 can be provided on the housing 40A of the drive unit 40. The crank rotation sensor 48 is configured to include a magnetic sensor that outputs a signal corresponding to the strength of the magnetic field. An annular magnet having south and north poles arranged adjacent to each other in the circumferential direction is provided on the input rotational shaft 12A, a member that rotates in cooperation with the input rotational shaft 12A, or a power transmission path extending between the input rotational shaft 12A and the first rotary body 24. The member that rotates in cooperation with the input rotational shaft 12A can include an output shaft of the motor 38.

The crank rotation sensor 48 outputs a signal corresponding to the rotational speed C of the input rotational shaft 12A. For example, in a case where the first one-way clutch is not provided between the input rotational shaft 12A and the first rotary body 24, the magnet can be provided on the first rotary body 24. The crank rotation sensor 48 can have any configuration that obtains information related to the rotational speed C of the input rotational shaft 12A and can include an optical sensor, an acceleration sensor, a gyro sensor, or a torque sensor instead of a magnetic sensor. The crank rotation sensor 48 is connected to the electronic controller 62 by a wireless communication device or an electric cable.

The human driving force detector 50 is configured to detect information related to a human driving force. The human driving force detector 50 is provided, for example, on the frame 18 of the human-powered vehicle 10, the drive unit 40, the crank 12, or the pedals 20A and 20B. The human driving force detector 50 can be provided on the housing 40A of the drive unit 40. The human driving force detector 50 includes, for example, a torque sensor. The torque sensor is configured to output a signal corresponding to torque applied to the crank 12 by the human driving force. For example, in a case where the first one-way clutch is provided on the power transmission path, it is preferred that the torque sensor is provided at the upstream side of the first one-way clutch in the power transmission path. The torque sensor includes, for example, a strain sensor, a magnetostrictive sensor, or a pressure sensor. The strain sensor includes a strain gauge.

The torque sensor is provided in the power transmission path or the vicinity of a member included in the power transmission path. The member included in the power transmission path includes, for example, the input rotational shaft 12A, a member that transmits the human driving force between the input rotational shaft 12A and the first rotary body 24, the crank arms 12B and 12C, and the pedals 20A and 20B. The human driving force detector 50 is connected to the electronic controller 62 via a wireless communication device or an electric cable. The human driving force detector 50 can have any configuration that obtains information related to a human driving force and can include, for example, a sensor that detects pressure applied to the pedals 20A and 20B or a sensor that detects tension of a chain.

The electronic controller 62 is configured to control the motor 38 that applies a propulsion force to the human-powered vehicle 10. The electronic controller 62 is configured to control the motor 38 in accordance with the human driving force that is input to the human-powered vehicle 10. The human driving force can be expressed as torque or power.

The electronic controller 62 is configured to control the motor 38, for example, so that the assist level of the motor 38 equals a predetermined assist level. In the present embodiment, the control states of the motor 38 differ from each other in an assist level of the motor 38. Preferably, the predetermined assist level includes predetermined assist levels that differ from each other in assist level. The electronic controller 62 changes the predetermined assist level in accordance with an operation performed by the rider on the operating device 54 to change the assist level.

The operating device 54 includes, for example, a first electrical switch for increasing the assist level and a second electrical switch for decreasing the assist level. In a case where the first electrical switch is operated and the assist level is not the maximum value, the electronic controller 62 increases the assist level. In a case where the second electrical switch is operated and the assist level is not the minimum value, the electronic controller 62 decreases the assist level. The electronic controller 62 is configured to store information related to the present assist level in the storage 64.

Preferably, the assist level includes at least one of a ratio of output of the motor 38 to the human driving force that is input to the human-powered vehicle 10, the maximum value of the output of the motor 38, and a restriction level that restricts changes in the output of the motor 38 in a case where the output of the motor 38 decreases. The ratio of an assist force generated by the motor 38 to the human driving force can be referred to as the assist ratio. The electronic controller 62 is configured to control the motor 38, for example, so that the ratio of the assist force generated by the motor 38 to the human driving force equals a predetermined assist ratio. The human driving force corresponds to a propulsion force of the human-powered vehicle 10 that is generated by the user rotating the crank 12. The assist force corresponds to a propulsion force of the human-powered vehicle 10 that is generated by rotation of the motor 38. The predetermined assist ratio is not fixed and can be changed, for example, in accordance with the human driving force, the rotational speed C of the input rotational shaft 12A, or the vehicle speed V, or any two or all of the human driving force, the rotational speed C of the input rotational shaft 12A, and the vehicle speed V.

In a case where the human driving force and the assist force are expressed as torque, the human driving force is referred to as a human torque HT, and the assist force is referred to as an assist torque MT. In a case the human driving force and the assist force are expressed as power, the human driving force is referred to as a human power HW, and the assist force is referred to as an assist power MW. The assist ratio can be a ratio of the assist torque MT to the human torque HT of the human-powered vehicle 10 or can be a ratio of the assist power MW of the motor 38 to the human power HW.

In the drive unit 40 of the present embodiment, the crank 12 is connected to the first rotary body 24 without using the shifting device, and an output of the motor 38 is input to the first rotary body 24. In a case where the crank 12 is connected to the first rotary body 24 without using the shifting device and the output of the motor 38 is input to the first rotary body 24, the human driving force corresponds to the driving force that is generated by the user rotating the crank 12 and is input to the first rotary body 24. In a case where the crank 12 is connected to the first rotary body 24 without using the shifting device and the output of the motor 38 is input to the first rotary body 24, the assist force corresponds to the driving force that is generated by rotation of the motor 38 and is input to the first rotary body 24. In a case where the output of the motor 38 is input to the first rotary body 24 through a speed reducer, the assist force corresponds to an output of the speed reducer.

The electronic controller 62 is configured to control the motor 38 so that the assist force is less than or equal to a predetermined value. As the restriction level of changes in output of the motor 38 increases, a changing amount of output of the motor 38 per unit time decreases relative to a changing amount of a control parameter of the motor 38 per unit time. As the restriction level of changes in output of the motor 38 decreases, the changing amount of output of the motor 38 per unit time increases relative to the changing amount of the control parameter of the motor 38 per unit time. The restriction level of changes in output of the motor 38 is inversely proportional to a response speed of the motor 38. The response speed of the motor 38 is expressed by the changing amount of output of the motor 38 per unit time relative to the changing amount of the control parameter of the motor 38 per unit time. Increases in the restriction level of changes in output of the motor 38 decrease the response speed of the motor 38.

The electronic controller 62 changes the restriction level, for example, using a filter. The filter includes, for example, a low-pass filter having a time constant. The electronic controller 62 changes the restriction level by changing the time constant of the filter. The electronic controller 62 can change the restriction level by changing a gain for calculating the output of the motor 38 from the human driving force. The filter is, for example, controlled by a processor executing predetermined software.

The electronic controller 62 is configured to control the transmission device 42 of the human-powered vehicle 10. Preferably, the electronic controller 62 is configured to change the transmission ratio R with the transmission device 42 in accordance with at least one of a traveling state of the human-powered vehicle 10 and a traveling environment of the human-powered vehicle 10. Preferably, the human-powered vehicle 10 includes a detector 52 configured to detect at least one of the traveling state of the human-powered vehicle 10 and the traveling environment of the human-powered vehicle 10.

Preferably, the electronic controller 62 is configured to control the transmission device 42 in accordance with a first parameter P1 related to the traveling state of the human-powered vehicle 10 and a predetermined first threshold value P1X. The electronic controller 62 controls the transmission device 42 so that the transmission ratio R is changed to maintain the first parameter P1 within a first range. The first range is specified by the predetermined first threshold value P1X. Preferably, the predetermined first threshold value P1X includes a first upper limit threshold value P1X1 and a first lower limit threshold value P1X2. The first range is less than or equal to the first upper limit threshold value P1X1 and greater than or equal to the first lower limit threshold value P1X2.

The first parameter P1 includes, for example, at least one of the rotational speed C of the crank 12 and the human driving force. The rotational speed C of the crank 12 can be an actual measurement value of the rotational speed C of the crank 12 or can be an estimation value. For example, in a case where the rotational speed C of the crank 12 shifts from inside to outside the first range, the electronic controller 62 controls the transmission device 42 to change the transmission ratio R so that the rotational speed C of the crank 12 shifts back to inside the first range. For example, in a case where the human driving force shifts from inside to outside the first range, the electronic controller 62 controls the transmission device 42 to change the transmission ratio R so that the human driving force shifts back to inside the first range.

In a case where the first parameter P1 is the rotational speed C of the crank 12, the detector 52 includes, for example, a first detector configured to detect information related to the rotational speed C of the crank 12. Preferably, the first detector has the same configuration as the crank rotation sensor 48. The first detector can include the crank rotation sensor 48. The first detector can include a sensor that detects a parameter correlated to the rotational speed C of the crank 12. The parameter correlated to the rotational speed C of the crank 12 is, for example, the vehicle speed V. The first detector can include the vehicle speed sensor 46. For example, in a case where the rotational speed C of the crank 12 is an actual measurement value of the rotational speed C of the crank 12, the first detector includes the crank rotation sensor 48. For example, in a case where the rotational speed C of the crank 12 is an estimation value of the rotational speed C of the crank 12, the first detector includes the vehicle speed sensor 46. The electronic controller 62 can be configured to calculate the rotational speed C of the crank 12 based on the vehicle speed V detected by the vehicle speed sensor 46 and the transmission ratio R. In a case where the first parameter P1 is a human driving force, the detector 52 includes, for example, a second detector configured to detect information related to the human driving force. Preferably, the second detector has the same configuration as the human driving force detector 50. The second detector can be formed by the human driving force detector 50.

Preferably, the electronic controller 62 is configured to control the transmission device 42 in accordance with a second parameter P2 related to the traveling environment of the human-powered vehicle 10 and a predetermined second threshold value P2X. The second range is specified by the predetermined second threshold value P2X. Preferably, the predetermined second threshold value P2X includes a second upper limit threshold value P2X1 and a second lower limit threshold value P2X2. The second range is less than or equal to the second upper limit threshold value P2X1 and greater than or equal to the second lower limit threshold value P2X2.

The second parameter P2 includes, for example, gradient S of a road on which the human-powered vehicle 10 is traveling. For example, in a case where the gradient S of the road on which the human-powered vehicle 10 is traveling shifts from inside the second range to outside the second range, the electronic controller 62 controls the transmission device 42 to change the transmission ratio R.

In a case where the second parameter P2 includes the gradient S of the travel road, the detector 52 includes, for example, an inclination detector. The inclination detector is configured to output information related to an inclined angle of the human-powered vehicle 10 in a traveling direction. The inclination detector includes, for example, at least one of an acceleration sensor and a gyro sensor. The gradient S can be detected by an inclination angle in a traveling direction of the human-powered vehicle 10. The gradient S corresponds to the inclination angle of the human-powered vehicle 10. The electronic controller 62 is, for example, configured to calculate the gradient S in accordance with the inclination angle in the traveling direction of the human-powered vehicle 10. The inclination angle includes a global positioning system (GPS) receiver. The electronic controller 62 can calculate the gradient S based on GPS information obtained by the GPS receiver and road surface gradients included in map information stored in advance in the storage 64. The inclination detector is connected to the electronic controller 62 via a wireless communication device or an electric cable.

A process for controlling the transmission device 42 with the electronic controller 62 will now be described with reference to FIG. 3. In the flowchart shown in FIG. 3, the electronic controller 62 controls the transmission device 42 in accordance with the first parameter P1 and the second parameter P2. In a case where electric power is supplied to, for example, the electronic controller 62, the electronic controller 62 starts the process and proceeds to step S11 of the flowchart shown in FIG. 3. In a case where the flowchart shown in FIG. 3 ends, the electronic controller 62 repeats the process from step S11 after a predetermined interval, for example, until the supply of electric power stops.

In step S11, the electronic controller 62 determines whether the first parameter P1 is outside the first range. In a case where the first parameter P1 is outside the first range, the electronic controller 62 proceeds to step S12. In step S12, the electronic controller 62 controls the transmission device 42 and then ends the process. In step S12, the electronic controller 62 controls the transmission device 42 so that the first parameter P1 shifts back to inside the first range based on a comparison result of the first parameter P1 used in step S11 and the predetermined first threshold value PlX. In a case where the present transmission ratio R of the transmission device 42 is the maximum value or the minimum value and the first parameter P1 cannot be shifted back to inside the first range even through the transmission device 42 is controlled, the electronic controller 62 can end the process without proceeding to step S12 from step S11.

In step S11, in a case where the first parameter P1 is not outside the first range, the electronic controller 62 proceeds to step S13. In step S13, the electronic controller 62 determines whether the second parameter P2 is outside the second range. In a case where the second parameter P2 is outside the second range, the electronic controller 62 proceeds to step S14. In a case where the second parameter P2 is not outside the second range, the electronic controller 62 ends the process.

In step S14, the electronic controller 62 controls the transmission device 42 and then ends the process. In step S14, the electronic controller 62 controls the transmission device 42 so that the second parameter P2 shifts back to inside the second range based on a comparison result of the second parameter P2 used in step S13 and second threshold value P2X. In a case where the present transmission ratio R of the transmission device 42 is the maximum value or the minimum value and the second parameter P2 cannot be shifted back to inside the second range even through the transmission device 42 is controlled, the electronic controller 62 can end the process without proceeding to step S14 from step S13.

The electronic controller 62 can be configured to control the transmission device 42 in accordance with only one of the first parameter P1 and the second parameter P2. In a case where the electronic controller 62 controls the transmission device 42 in accordance with the first parameter P1 and does not control the transmission device 42 in accordance with the second parameter P2, steps S13 and S14 can be omitted. In a case where steps S13 and S14 are omitted and the determination of step S11 is NO, the electronic controller 62 ends the process. In a case where the electronic controller 62 controls the transmission device 42 in accordance with the second parameter P2 and does not control the transmission device 42 in accordance with the first parameter P1, steps S11 and S12 can be omitted. In a case where steps S11 and step S12 are omitted and electric power is supplied to, for example, the electronic controller 62, the electronic controller 62 starts the process and proceeds to step S13. In a case where the flowchart shown in FIG. 3 ends, the electronic controller 62 repeats the process from step S13 after a predetermined interval, for example, until the supply of electric power stops.

In a case where one of the control states is switched to a further one of the control states, the electronic controller 62 is configured to restrict a shifting action of the transmission device 42 until a predetermined condition is satisfied. Preferably, the control states differ from each other in an assist level of the motor 38. The case where the one of the control states is switched to the further one of the control states includes a case where the assist level of the motor 38 is increased. In a case where the assist level is changed to an assist level that is greater than the present assist level, the electronic controller 62 determines that the one of the control states is switched to the further one of the control states.

Preferably, the shifting action of the transmission device 42 includes a shifting action that increases the transmission ratio R with the transmission device 42. The electronic controller 62 restricts the shifting action of the transmission device 42 that increases the transmission ratio R. For example, in a case where the electronic controller 62 controls the transmission device 42 to change the transmission ratio R in accordance with the rotational speed C of the crank 12, the electronic controller 62 can restrict the shifting action of the transmission device 42 that increases the transmission ratio R by increasing the first upper limit threshold value P1X1 and the first lower limit threshold value P1X2 of the first range by a first value. For example, in a case where the electronic controller 62 controls the transmission device 42 to change the transmission ratio R in accordance with the human driving force, the electronic controller 62 can restrict the shifting action of the transmission device 42 that increases the transmission ratio R by decreasing the first upper limit threshold value P1X1 and the first lower limit threshold value P1X2 of the first range by a second value.

In a case where the electronic controller 62 controls the transmission device 42 in accordance with the first parameter P1 related to the traveling state of the human-powered vehicle 10 and the predetermined first threshold value P1X, the electronic controller 62 can be configured to restrict the shifting action of the transmission device 42 by changing the predetermined first threshold value P1X. In a case where the electronic controller 62 controls the transmission device 42 in accordance with the second parameter P2 related to the traveling environment of the human-powered vehicle 10 and the predetermined second threshold value P2X, the electronic controller 62 can be configured to restrict the shifting action of the transmission device 42 by changing the predetermined second threshold value P2X.

The shifting action of the transmission device 42 can include a shifting action that decreases the transmission ratio R with the transmission device 42. The electronic controller 62 restricts the shifting action of the transmission device 42 that decreases the transmission ratio R. The electronic controller 62 can restrict only one of a first shifting action of the transmission device 42 that increases the transmission ratio R and a second shifting action of the transmission device 42 that decreases the transmission ratio R. For example, among the first shifting action, which increases the transmission ratio R with the transmission device 42, and the second shifting action, which decreases the transmission ratio R with the transmission device 42, the shifting action of the transmission device 42 can be configured to include only the first shifting action. In a case where the electronic controller 62 restricts only one of the first shifting action, which increases the transmission ratio R with the transmission device 42, and the second shifting action, which decreases the transmission ratio R with the transmission device 42, the electronic controller 62 can be configured to restrict the only one of the first shifting action and the second shifting action of the transmission device 42 by increasing or decreasing the upper limit threshold values P1X1 and P2X1 and the lower limit threshold values P1X2 and P2X2. In a case where the electronic controller 62 restricts both the first shifting action, which increases the transmission ratio R with the transmission device 42, and the second shifting action, which decreases the transmission ratio R with the transmission device 42, the electronic controller 62 can be configured to restrict the shifting action of the transmission device 42 by increasing the upper limit threshold values P1X1 and P2X1 and the lower limit threshold values P1X2 and P2X2.

Preferably, the predetermined condition is satisfied in a case where a predetermined first period T1 elapses from when switching from the one of the control states to the further one of the control states. For example, the predetermined first period T1 can include a predetermined first time. Preferably, the predetermined first time is greater than or equal to one second and less than or equal to five seconds. Preferably, the predetermined first time is three seconds.

For example, the predetermined first period T1 can include a period during which a rotation amount of the wheel 14 of the human-powered vehicle 10 becomes a predetermined rotation amount. Preferably, the predetermined rotation amount is greater than or equal to 360 degrees and less than or equal to 3600 degrees. The predetermined rotation amount is, for example, greater than or equal to 1180 degrees and less than or equal to 2520 degrees. Preferably, the predetermined rotation amount is, for example, 2160 degrees. The predetermined rotation amount can correspond to the travel distance of the human-powered vehicle 10. For example, the predetermined rotation amount is a rotation amount in which the travel distance of the human-powered vehicle 10 corresponds to a predetermined distance. The predetermined distance is, for example, greater than or equal to 10 meters and less than or equal to 20 meters. The predetermined distance is, for example, greater than or equal to 12 meters and less than or equal to 14 meters. The predetermined distance is, for example, 13 meters.

The predetermined first period T1 can include a period during which a rotation amount of the first rotary body 24 becomes a predetermined first rotation amount. In a case where the predetermined first period T1 includes the period during which the rotation amount of the first rotary body 24 becomes the predetermined first rotation amount, it is preferred that the predetermined first rotation amount is calculated based on the present transmission ratio R of the transmission device 42. The predetermined first rotation amount is, for example, a value obtained by dividing the predetermined rotation amount by the present transmission ratio R of the transmission device 42. The predetermined first period T1 can include a period during which a rotation amount of the second rotary body 26 becomes a predetermined second rotation amount. The predetermined second rotation amount is, for example, the predetermined rotation amount.

The case where the one of the control states is switched to the further one of the control states can include a case where the one of the control states is switched to the further one of the control states in a state in which acceleration B of the human-powered vehicle 10 in the traveling direction of the human-powered vehicle 10 is greater than or equal to a predetermined first acceleration B1. In this case, the predetermined condition is satisfied in a case where the acceleration B of the human-powered vehicle 10 becomes less than or equal to a predetermined second acceleration B2 that is less than or equal to the predetermined first acceleration B1. Information related to the predetermined first acceleration B1 and information related to the predetermined second acceleration B2 are stored in the storage 64. Information related to the predetermined first acceleration B1 and information related to the predetermined second acceleration B2 can be set or changed by a user with the electronic controller 62 or an external device that is connected to the storage 64.

In a case where the acceleration B of the human-powered vehicle 10 in the traveling direction of the human-powered vehicle 10 is greater than or equal to the predetermined first acceleration B1 and the one of the control states is switched to the further one of the control states, the human-powered vehicle 10 can include an acceleration detector 56. The acceleration detector 56 is configured to output information related to the acceleration B in a direction in which the human-powered vehicle 10 travels forward. The acceleration detector 56 can include an acceleration sensor or can include a vehicle speed sensor similar to the vehicle speed sensor 46. The acceleration detector 56 is connected to the electronic controller 62 via a wireless communication device or an electric cable. In a case where the acceleration detector 56 includes a vehicle speed sensor, the electronic controller 62 differentiates the vehicle speed V to obtain information related to acceleration B in the direction in which the human-powered vehicle 10 travels forward. The vehicle speed sensor of the acceleration detector 56 can be formed by the vehicle speed sensor 46.

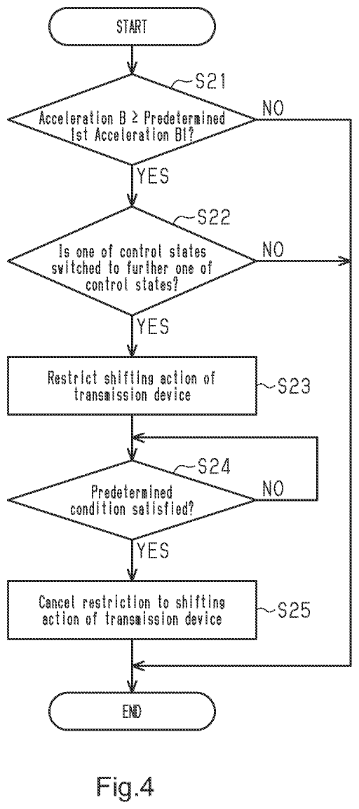

A process for restricting the shifting action of the transmission device 42 with the electronic controller 62 will now be described with reference to FIG. 4. In a case where electric power is supplied to, for example, the electronic controller 62, the electronic controller 62 starts the process and proceeds to step S21 of the flowchart shown in FIG. 4. In a case where the flowchart shown in FIG. 4 ends, the electronic controller 62 repeats the process from step S21 after a predetermined interval, for example, until the supply of electric power stops.

In step S21, the electronic controller 62 determines the acceleration B is greater than or equal to the predetermined first acceleration B1. In a case where the acceleration B is not greater than or equal to the predetermined first acceleration B1, the electronic controller 62 ends the process. In a case where the acceleration B is greater than or equal to the predetermined first acceleration B1, the electronic controller 62 proceeds to step S22.

In step S22, the electronic controller 62 determines whether one of the control states is switched to a further one of the control states. In a case where one of the control states is not switched to a further one of the control states, the electronic controller 62 ends the process. In a case where one of the control states is switched to a further one of the control states, the electronic controller 62 proceeds to step S23.

In step S23, the electronic controller 62 restricts the shifting action of the transmission device 42 and proceeds to step S24. In step S23, for example, the electronic controller 62 restricts the shifting action of the transmission device 42 by changing the first range and the second range. For example, the electronic controller 62 restricts the shifting action of the transmission device 42 by changing the predetermined first threshold value P1X to increase the transmission ratio R. For example, the electronic controller 62 restricts the shifting action of the transmission device 42 by changing the predetermined second threshold value P2X to decrease the transmission ratio R.

In step S24, the electronic controller 62 determines whether a predetermined condition is satisfied. The electronic controller 62 determines that the predetermined condition is satisfied in at least one of a case where the predetermined first period T1 elapses from when switching from the one of the control states to the further one of the control states and a case where the acceleration B of the human-powered vehicle 10 becomes less than the predetermined second acceleration B2. The electronic controller 62 can be configured to determine that the predetermined condition is satisfied only in a case where the acceleration B of the human-powered vehicle 10 is less than the predetermined second acceleration B2. In a case where the predetermined condition is not satisfied, the electronic controller 62 proceeds to step S24. In a case where the predetermined condition is satisfied, the electronic controller 62 proceeds to step S25.

In step S25, the electronic controller 62 cancels the restriction to the shifting action of the transmission device 42 and then ends the process. The electronic controller 62 shifts, for example, the first range and the second range to the first range and the second range that were used in step S23 and cancels the restriction to the shifting action of the transmission device 42.

### Modifications

The description related to the above embodiment exemplifies, without any intention to limit, applicable forms of a human-powered vehicle control device according to the present disclosure. The human-powered vehicle control device according to the present disclosure can be applied to, for example, modifications of the embodiment that are described below and combinations of at least two of the modifications that do not contradict each other. In the modifications described hereinafter, same reference characters are given to those elements that are the same as the corresponding elements of the above embodiment. Such elements will not be described in detail.

The case where the one of the control states is switched to the further one of the control states can include a case where the one of the control states is switched to the further one of the control states in a state in which load E on the rider of the human-powered vehicle 10 is greater than or equal to a predetermined first load E1, and the predetermined condition can be satisfied in a case where the load E on the rider is less than a predetermined second load E2 that is less than or equal to the predetermined first load E1. The load E on the rider is, for example, expressed by a human driving force. Information related to the load E on the rider is, for example, detected by the human driving force detector 50. The load E on the rider can be detected by a detector that differs from the human driving force detector 50.

The predetermined first load E1 is, for example, the human driving force applied to the input rotational axle 12A and is a value in a range of 40 Nm or greater and 60 Nm or less. The predetermined first load E1 is the human driving force applied to the input rotational axle 12A that is, for example, 50 Nm. The predetermined second load E2 is, for example, the human driving force applied to the input rotational axle 12A and is a value in a range of 10 Nm or greater and 20 Nm or less. The load E on the rider can be expressed by at least one of heart rate and pulse of the rider. Information related to the predetermined first load E1 and information related to the predetermined second load E2 are stored in the storage 64. Information related to the predetermined first load E1 and information related to the predetermined second load E2 can be set or changed by a user with the electronic controller 62 or an external device that is connected to the storage 64. The external device includes, for example, a smartphone, a tablet computer, or a personal computer.

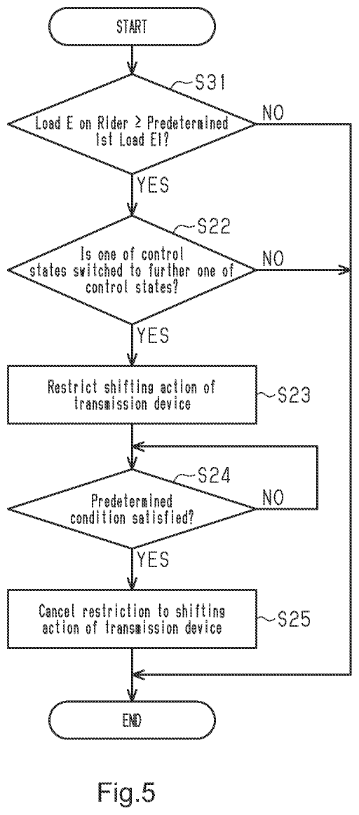

The electronic controller 62 can execute, for example, the flowchart shown in FIG. 5 in which step S21 in the flowchart shown in FIG. 4 is replaced with step S31. In the flowchart shown in FIG. 5, the same process as in the flowchart shown in FIG. 4 will not be described in detail. For example, in a case where electric power is supplied to the electronic controller 62, the electronic controller 62 starts the process and proceeds to step S31 of the flowchart shown in FIG. 5. In a case where the flowchart shown in FIG. 5 ends, the electronic controller 62 repeats the process from step S31 after a predetermined interval, for example, until the supply of electric power stops. In step S31, the electronic controller 62 determines whether the load E on the rider is greater than or equal to the predetermined first load E1. In a case where the load E on the rider is greater than or equal to the predetermined first load E1, the electronic controller 62 proceeds to step S22.

In step S24 shown in FIG. 5, the electronic controller 62 determines that the predetermined condition is satisfied in at least one of a case where the predetermined first period T1 elapses from when switching from the one of the control states to the further one of the control states and a case where the load E on the rider becomes less than the predetermined second load E2. The electronic controller 62 can be configured to determine that the predetermined condition is satisfied in a case where the load E on the rider is less than the predetermined second load E2.

The case where the one of the control states is switched to the further one of the control states can include a case where the one of the control states is switched to the further one of the control states in a state in which the gradient S of the road on which the human-powered vehicle 10 is traveling is greater than or equal to a predetermined first gradient S1, and the predetermined condition can be satisfied in a case where the gradient S of the road on which the human-powered vehicle 10 is traveling is less than a predetermined second gradient S2 that is less than or equal to the predetermined first gradient S1. Information related to the gradient S of the road on which the human-powered vehicle 10 is traveling is, for example, detected by an inclination detector included in the detector 52. Information related to the gradient S of the road on which the human-powered vehicle 10 is traveling can be detected by a detector that differs from the inclination detector included in the detector 52.

The predetermined first gradient S1 is, for example, a value in a range from 2 percent to 40 percent. The predetermined first gradient S1 is, for example, 5 percent. The predetermined second gradient S2 is, for example, 3 percent or higher and 15 percent or lower. The predetermined first gradient S1 can be, for example, a value in a range from 20 percent to 40 percent. The predetermined first gradient S1 can be, for example, 25 percent. The predetermined second gradient S2 can be, for example, 5 percent or higher and 15 percent or lower. Information related to the predetermined first gradient S1 and information related to the predetermined second gradient S2 are stored in the storage 64. Information related to the predetermined first gradient S1 and information related to the predetermined second gradient S2 can be set or changed by a user with the electronic controller 62 or an external device that is connected to the storage 64. The predetermined first gradient S1 and the predetermined second gradient S2 can be, for example, 5 percent.

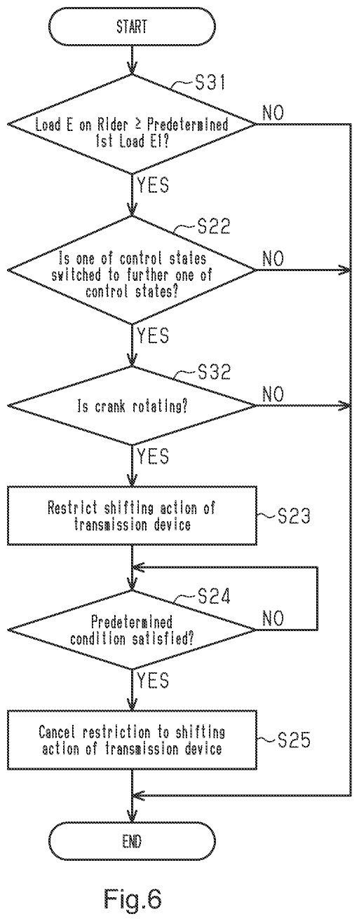

The case where the one of the control states is switched to the further one of the control states can include a case where the one of the control states is switched to the further one of the control states in a state in which the load E on the rider of the human-powered vehicle 10 is greater than or equal to the predetermined first load E1 and the crank of the human-powered vehicle 10 is rotating, and the predetermined condition can be satisfied in a case where the load E on the rider is less than the predetermined second load E2 that is less than or equal to the predetermined first load E1. The electronic controller 62 can execute, for example, the flowchart shown in FIG. 6 in which step S32 is added to the flowchart shown in FIG. 5. In the flowchart shown in FIG. 6, the same process as in the flowchart shown in FIGS. 4 and 5 will not be described in detail. For example, in a case where electric power is supplied to the electronic controller 62, the electronic controller 62 starts the process and proceeds to step S31 of the flowchart shown in FIG. 6. In a case where the flowchart shown in FIG. 6 ends, the electronic controller 62 repeats the process from step S31 after a predetermined interval, for example, until the supply of electric power stops.

In step S22 shown in FIG. 6, in a case where the determination of the electronic controller 62 is YES, the electronic controller 62 proceeds to step S32. In step S32, the electronic controller 62 determines whether the crank 12 is rotating. The electronic controller 62 ends the process in a case where the crank 12 is not rotating. In a case where the crank 12 is rotating, the electronic controller 62 proceeds to step S23. In the flowchart shown in FIG. 6, the determination process of step S32 can be executed before the determination process of step S31 and the determination process of step S22.

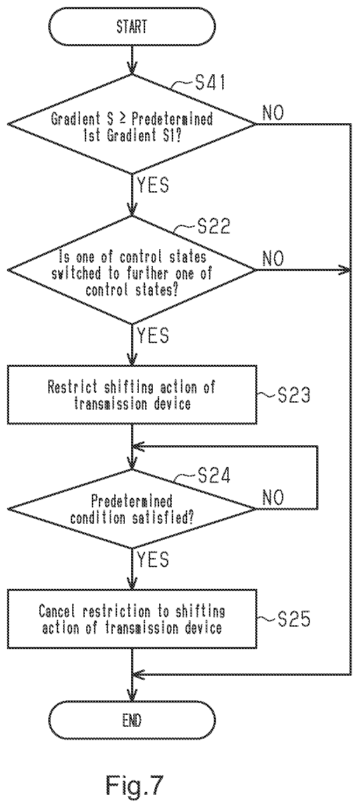

The electronic controller 62 can execute, for example, the flowchart shown in FIG. 7 in which step S21 in the flowchart shown in FIG. 4 is replaced with step S41. In the flowchart shown in FIG. 7, the same process as in the flowchart shown in FIG. 4 will not be described in detail. For example, in a case where electric power is supplied to the electronic controller 62, the electronic controller 62 starts the process and proceeds to step S41 of the flowchart shown in FIG. 7. In a case where the flowchart shown in FIG. 7 ends, the electronic controller 62 repeats the process from step S41 after a predetermined interval, for example, until the supply of electric power stops. In step S41, the electronic controller 62 determines whether the gradient S is greater than or equal to the predetermined first gradient S1. In a case where the gradient S is greater than or equal to the predetermined first gradient S1, the electronic controller 62 proceeds to step S22.

In step S24 shown in FIG. 7, the electronic controller 62 determines that the predetermined condition is satisfied in at least one of a case where the predetermined first period T1 elapses from when switching from the one of the control states to the further one of the control states and a case where the gradient S of the road on which the human-powered vehicle 10 is traveling becomes less than the predetermined second gradient S2. The electronic controller 62 can be configured to determine that the predetermined condition is satisfied in a case where the gradient S of the road on which the human-powered vehicle 10 is traveling is less than the predetermined second gradient S2.

The case where the one of the control states is switched to the further one of the control states can include a case where the one of the control states is switched to the further one of the control states in a state in which a pitch angle D of the human-powered vehicle 10 is greater than or equal to a predetermined first pitch angle D1, and the predetermined condition can be satisfied in a case where, the pitch angle D of the human-powered vehicle 10 is less than a predetermined second pitch angle D2 that is less than or equal to the predetermined first pitch angle D1. Information related to the pitch angle D of the human-powered vehicle 10 is, for example, detected by the inclination detector included in the detector 52. Information related to the pitch angle D of the human-powered vehicle 10 can be detected by a detector that differs from the inclination detector included in the detector 52.

The predetermined first pitch angle D1 is, for example, a value in a range from 2 degrees to 20 degrees. The predetermined first pitch angle D1 is, for example, 2.86 degrees. The predetermined second pitch angle D2 is, for example, a value in a range from 2 degrees to 9 degrees. The predetermined first pitch angle D1 can be, for example, a value in a range from 10 degrees to 20 degrees. The predetermined first pitch angle D1 can be, for example, 14 degrees. The predetermined second pitch angle D2 can be, for example, a value in a range from 3 degrees to 9 degrees. Information related to the predetermined first pitch angle D1 and information related to the predetermined second pitch angle D2 are stored in the storage 64. Information related to the predetermined first pitch angle D1 and information related to the predetermined second pitch angle D2 can be set or changed by a user with the electronic controller 62 or an external device that is connected to the storage 64. The predetermined first pitch angle D1 and the predetermined second pitch angle D2 can be, for example, 2.86 degrees.

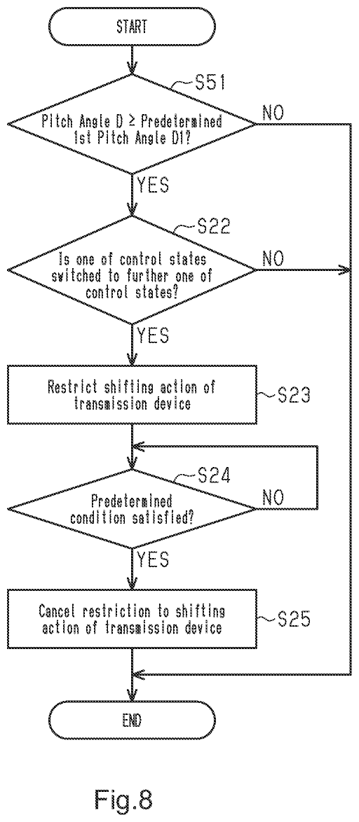

The electronic controller 62 can execute, for example, the flowchart shown in FIG. 8 in which step S21 in the flowchart shown in FIG. 4 is replaced with step S41. In the flowchart shown in FIG. 8, the same process as in the flowchart shown in FIG. 4 will not be described in detail. For example, in a case where electric power is supplied to the electronic controller 62, the electronic controller 62 starts the process and proceeds to step S51 of the flowchart shown in FIG. 8. In a case where the flowchart shown in FIG. 8 ends, the electronic controller 62 repeats the process from step S51 after a predetermined interval, for example, until the supply of electric power stops. In step S51, the electronic controller 62 determines whether the pitch angle D is greater than or equal to the predetermined first pitch angle D1. In a case where the pitch angle D is greater than or equal to the predetermined first pitch angle D1, the electronic controller 62 proceeds to step S22.

In step S24 shown in FIG. 8, the electronic controller 62 determines that the predetermined condition is satisfied in at least one of a case where the predetermined first period T1 elapses from when switching from the one of the control states to the further one of the control states and a case where the pitch angle D of the human-powered vehicle 10 becomes less than the predetermined second pitch angle D2. The electronic controller 62 can be configured to determine that the predetermined condition is satisfied in a case where the pitch angle D of the human-powered vehicle 10 is less than the predetermined second pitch angle D2.

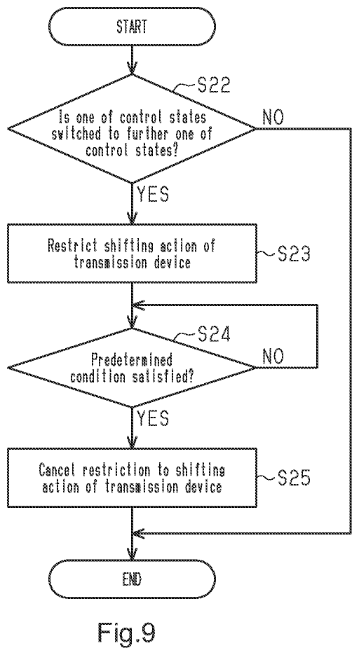

As long as the electronic controller 62 is configured to restrict the shifting action of the transmission device 42 until a predetermined condition is satisfied in a case where one of the control states is switched to a further one of the control states, other configurations can be omitted. The electronic controller 62 can execute, for example, the flowchart shown in FIG. 9 in which step S21 is omitted from the flowchart shown in FIG. 4. For example, in a case where electric power is supplied to the electronic controller 62, the electronic controller 62 starts the process and proceeds to step S22 of the flowchart shown in FIG. 9. In a case where the flowchart shown in FIG. 9 ends, the electronic controller 62 repeats the process from step S22 after a predetermined interval, for example, until the supply of electric power stops.

In step S24 shown in FIG. 9, the electronic controller 62 determines that the predetermined condition is satisfied in a case where the predetermined first period T1 elapses from when switching from the one of the control states to the further one of the control states.

The case where the one of the control states is switched to the further one of the control states can include a case where the assist level of the motor 38 is decreased. The case where the one of the control states is switched to the further one of the control states can include both a case where the assist level of the motor 38 is increased and a case where the assist level of the motor 38 is decreased.

The electronic controller 62 can restrict the shifting action of the transmission device 42 that decreases the transmission ratio R. For example, in a case where the electronic controller 62 controls the transmission device 42 to change the transmission ratio R in accordance with the rotational speed C of the crank 12, the electronic controller 62 restricts the shifting action of the transmission device 42 that decreases the transmission ratio R by decreasing the first upper limit threshold value P1X1 and the first lower limit threshold value P1X2 of the first range by a third value. For example, in a case where the electronic controller 62 controls the transmission device 42 to change the transmission ratio R in accordance with the human driving force, the electronic controller 62 restricts the shifting action of the transmission device 42 that decreases the transmission ratio R by increasing the first upper limit threshold value P1X1 and the first lower limit threshold value P1X2 of the first range by a fourth value.

In a case where one of the control states is switched to a further one of the control states, the electronic controller 62 is configured to prohibit the shifting action of the transmission device 42 until a predetermined condition is satisfied. In this case, for example, in a case where one of the control states is switched to a further one of the control states, the electronic controller 62 can be configured to prohibit the shifting action of the transmission device 42 even through a shifting operating device is operated. The shifting operating device is, for example, provided separately from the operating device 54. The shifting operating device includes, for example, an electrical switch that can be manually operated with a finger of the rider. The shifting operating device can include, for example, a smartphone. The shifting operating device can be electrically connected to the electronic controller 62 by an electric cable or can be connected to the electronic controller 62 through wireless communication.

The electronic controller 62 can be configured to automatically change the predetermined assist level in accordance with at least one of the traveling state of the human-powered vehicle 10 and the traveling environment of the human-powered vehicle 10 instead of or in addition of an operation performed by the rider on the operating device 54.

A control system for a human-powered vehicle can be formed by the human-powered vehicle control device 60 and at least one of the vehicle speed sensor 46, the crank rotation sensor 48, the human driving force detector 50, the detector 52, the acceleration detector 56, the operating device 54, the transmission device 42, and the battery 36.

In this specification, the phrase “at least one of” as used in this disclosure means “one or more” of a desired choice. As one example, the phrase “at least one of” as used in this disclosure means “only one choice” or “both of two choices” in a case where the number of choices is two. In another example, in this specification, the phrase “at least one of” as used in this disclosure means “only one single choice” or “any combination of equal to or more than two choices” if the number of its choices is equal to or more than three.

What is claimed is:

1. A human-powered vehicle control device for a human-powered vehicle having a transmission device and a motor, which is configured to apply a propulsion force to the human-powered vehicle, the human-powered vehicle control device comprising:
an electronic controller configured to control the transmission device of the human-powered vehicle,
the electronic controller being configured to restrict a shifting action of the transmission device until a predetermined condition is satisfied in a case where one of a control states of the motor is switched to a further one of the control states of the motor.

2. The human-powered vehicle control device according to claim 1, wherein
the electronic controller is configured to change a transmission ratio with the transmission device in accordance with at least one of a traveling state of the human-powered vehicle and a traveling environment of the human-powered vehicle.

3. The human-powered vehicle control device according to claim 2, wherein
the electronic controller is configured to control the transmission device in accordance with a first parameter, related to the traveling state of the human-powered vehicle, and a predetermined first threshold value; and
the electronic controller is configured to change the predetermined first threshold value to restrict the shifting action of the transmission device.

4. The human-powered vehicle control device according to claim 2, wherein
the electronic controller is configured to control the transmission device in accordance with a second parameter, related to the traveling environment of the human-powered vehicle, and a predetermined second threshold value; and
the electronic controller is configured to change the predetermined second threshold value to restrict the shifting action of the transmission device.

5. The human-powered vehicle control device according to claim 1, wherein
the predetermined condition is satisfied in a case where a predetermined first period elapses from when switching from the one of the control states to the further one of the control states.

6. The human-powered vehicle control device according to claim 5, wherein
the predetermined first period includes a predetermined first time.

7. The human-powered vehicle control device according to claim 6, wherein
the predetermined first time is greater than or equal to one second and less than or equal to five seconds.

8. The human-powered vehicle control device according to claim 5, wherein
the predetermined first period includes a period during which a rotation amount of a wheel of the human-powered vehicle becomes a predetermined rotation amount.

9. The human-powered vehicle control device according to claim 8, wherein
the predetermined rotation amount is greater than or equal to 360 degrees and less than or equal to 3600 degrees.

10. The human-powered vehicle control device according to claim 1, wherein
the case where the one of the control states is switched to the further one of the control states includes a case where the one of the control states is switched to the further one of the control states in a state in which acceleration of the human-powered vehicle in a traveling direction of the human-powered vehicle is greater than or equal to a predetermined first acceleration, and
the predetermined condition is satisfied in a case where the acceleration of the human-powered vehicle becomes less than a predetermined second acceleration that is less than or equal to the predetermined first acceleration.

11. The human-powered vehicle control device according to claim 1, wherein
the case where the one of the control states is switched to the further one of the control states includes a case where the one of the control states is switched to the further one of the control states in a state in which load on a rider of the human-powered vehicle is greater than or equal to a predetermined first load, and
the predetermined condition is satisfied in a case where the load on the rider is less than a predetermined second load that is less than or equal to the predetermined first load.

12. The human-powered vehicle control device according to claim 1, wherein
the case where the one of the control states is switched to the further one of the control states includes a case where the one of the control states is switched to the further one of the control states and a crank of the human-powered vehicle is rotating in a state in which load on a rider of the human-powered vehicle is greater than or equal to a predetermined first load, and
the predetermined condition is satisfied in a case where the load on the rider is less than a predetermined second load that is less than or equal to the predetermined first load.

13. The human-powered vehicle control device according to claim 1, wherein
the case where the one of the control states is switched to the further one of the control states includes a case where the one of the control states is switched to the further one of the control states in a state in which gradient of a road on which the human-powered vehicle is traveling is greater than or equal to a predetermined first gradient, and
the predetermined condition is satisfied in a case where the gradient of the road on which the human-powered vehicle is traveling becomes less than a predetermined second gradient that is less than or equal to the predetermined first gradient.

14. The human-powered vehicle control device according to claim 1, wherein
the case where the one of the control states is switched to the further one of the control states includes a case where the one of the control states is switched to the further one of the control states in a state in which a pitch angle of the human-powered vehicle is greater than or equal to a predetermined first pitch angle, and
the predetermined condition is satisfied in a case where the pitch angle of the human-powered vehicle becomes less than a predetermined second pitch angle that is less than or equal to the predetermined first pitch angle.

15. The human-powered vehicle control device according to claim 1, wherein
the control states differ from each other in an assist level of the motor, and
the case where the one of the control states is switched to the further one of the control states includes a case where the assist level of the motor is increased.

16. The human-powered vehicle control device according to claim 1, wherein
the shifting action of the transmission device includes a shifting action that increases the transmission ratio with the transmission device.

17. The human-powered vehicle control device according to claim 1, wherein
the shifting action of the transmission device includes a shifting action that decreases the transmission ratio with the transmission device.

18. The human-powered vehicle control device according to claim 1, wherein
among a first shifting action that increases the transmission ratio with the transmission device and a second shifting action that decreases the transmission ratio with the transmission device, the shirting action of the transmission device includes only the first shifting action.

19. The human-powered vehicle control device according to claim 1, wherein
the electronic controller is further configured to control the motor.

20. The human-powered vehicle control device according to claim 1, further comprising:
an input unit configured to receive information related to the control states, and
wherein the electronic controller is further configured to obtain the information related to the control states via the input unit.
